(19) United States
(12) Patent Application Publication
(10) Pub. No.: US 2020/0069511 A1
(43) Pub. Date: Mar. 5, 2020

(54) VIBRATION RING

(71) Applicant: Queen City Boxes, Inc., New York, NY (US)

(72) Inventor: Julia F. Lopez, Laurence Harbor, NJ (US)

(21) Appl. No.: 16/264,160

(22) Filed: Jan. 31, 2019

Related U.S. Application Data
(60) Provisional application No. 62/724,122, filed on Aug. 29, 2018.

(51) Int. Cl. A61H 23/02; A61H 19/00

(52) U.S. Cl. CPC A61H 23/02; F16M 13/04; A61H 19/34

(57) ABSTRACT

A vibration ring having a housing and a ring band, where the housing can be mounted on the ring band in a plurality of orientations.

### FIELD OF THE INVENTION

The present invention relates to the field of personal vibration devices and more particularly to the field of wearable vibrators.

### BACKGROUND OF THE INVENTION

Vibration devices are popular for personal physical therapy, allowing a user to administer vibrational stimulus to the body.

More recently, wearable vibration devices have become popular. An example of a wearable vibration ring can be found in DE202016000683, which issued on Feb. 24, 2016.

However, the wearable vibration devices known are lacking in versatility, where they are only wearable in a particular, manufacturer defined fashion. It is therefore an object of the invention to provide a vibration ring that can be configured in different ways to suit the wearer.

It is a further object of the invention to provide a vibration ring with a plurality of settings, providing a plurality of user determinable vibration modes and/or a variety of user determinable vibration speeds.

### SUMMARY OF THE INVENTION

The present invention is directed to a vibration ring comprising a housing and a ring band, wherein the housing can be mounted on the ring band in a plurality of orientations. In a preferred embodiment, the ring band can be adaptable between a first orientation, with the ring band perpendicular to the length of the housing, and a second orientation, with the ring band parallel to the length of the housing, the orientation being configurable by the user. In a most preferred embodiment, the vibration ring can be user controlled to operate at various vibration modes and vibration speeds.

The preferred vibration ring comprises a 2-axis and/or 3-axis gyroscope accelerometer, a motor, a computer chip/printed circuit board or other processor for storing various user selectable settings, a control activator to allow user determination of the vibration settings, and a power source for powering the accelerometer, motor and processor. In the most preferred embodiment, the power source is a rechargeable battery with a jack or contacts accessible on the exterior of the housing for recharging, however, any suitable power source and/or charging device capable of powering the functions of the vibration ring can be used.

Any suitable structure can be used to connect the ring band and the housing, as long as it permits the user to orient the housing on the ring band. In a preferred embodiment, the housing and the ring band have cooperating elements for attaching the housing to the ring band, so that the ring band can be removed from the housing and reattached in an alternative orientation. This embodiment permits the use of different sized ring bands with a single housing, where the user can attach the housing to a ring band sized to fit the user's finger. Alternatively, the ring band can be rotationally or slidably attached to the housing so that the orientation is changed without removing the housing from the ring band.

Any structure for connecting the ring band to the housing in various orientations can be used, as long as it allows a user to easily change between various orientations and, when positioned in a particular orientation, the ring band stays firmly in place without rattling or slipping. A preferred structure includes a detent having an enlarged distal end, the detent extending from a portion of the housing and being engaged by a receiver on the ring band having a cooperating element using a friction fit.

In a most preferred embodiment, the mounting structure further comprises a releasable securing member to help maintain the housing in the user determined orientation on the ring band, the securing member being one or more of a magnet, clasp, catch, pin, snap, clamp, spring ball, or the like, including combinations thereof.

The housing preferably comprises two or more housing sections that cooperate to contain and protect the electronic components, preferably including the motor, printed circuit board and battery. When the housing sections are attached, the housing is preferably water resistant, so that it can be cleaned or submerged without damaging the interior components.

Although any suitable control can be used to activate the user settings, including controls with wireless connections such as Bluetooth, Wi-Fi, etc., one or more physical activators may be placed on the exterior of the housing for user interface. For example, physical activators can include individual power button, mode and speed buttons for turning the vibration on and off and selecting various mode and speed options, or a multi-function button that controls all of these aspects.

In another preferred embodiment, the settings of the vibration ring can be selected and saved by the user in the memory of the computer chip. This permits the user to select and store particular combinations of mode and speed settings that can be scrolled through or returned to for future use.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a top perspective view of a preferred embodiment of the vibration ring of the present invention.

FIG. 2 is a bottom perspective view of the preferred embodiment of the vibration ring of FIG. 1.

FIG. 3 is a bottom perspective view of the preferred embodiment of the vibration ring of FIG. 1 with the ring band disconnected from the housing.

FIG. 4 is a bottom perspective view of the preferred embodiment of the vibration ring of FIG. 1 with the ring band connected to the housing.

FIG. 5A is a perspective view of the top housing section of the vibration ring of FIG. 1.

FIG. 5B is a bottom plan view of the top housing section of FIG. 5A.

FIG. 5C is a front elevation view of the top housing section of FIG. 5A.

FIG. 5D is a side elevation view of the top housing section of FIG. 5A.

FIG. 6A is a perspective view of the bottom housing section of the vibration ring of FIG. 1.

FIG. 6B is a top plan view of the bottom housing section of FIG. 6A.

FIG. 6C is a front elevation view of the bottom housing section of FIG. 6A.

FIG. 6D is a side elevation view of the bottom housing section of FIG. 6A.

FIG. 7A is a perspective view of the ring band of the vibration ring of FIG. 1.

FIG. 7B is a front elevation view of the ring band of FIG. 7A.

FIG. 7C is a top plan view of the ring band of FIG. 7A.

FIG. 7D is a side elevation view of the ring band of FIG. 7A.

FIG. 8 is an electronics schematic for the preferred vibration ring of the present invention.

FIG. 9 is a vibrations setting flow diagram for the preferred vibration ring of the present invention.

FIG. 10 is a charging flow diagram for the preferred vibration ring of the present invention.

### DETAILED DESCRIPTION OF THE PREFERRED EMBODIMENT

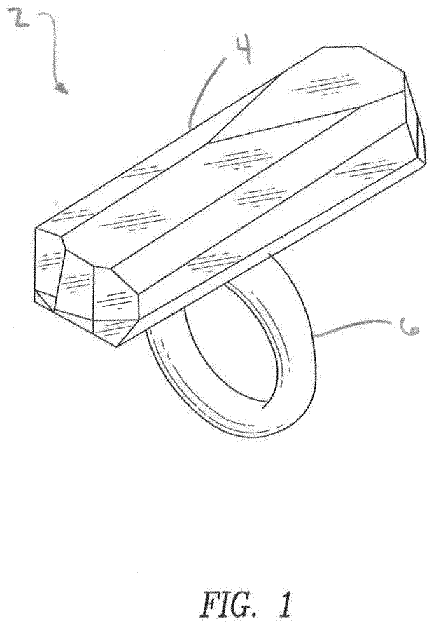

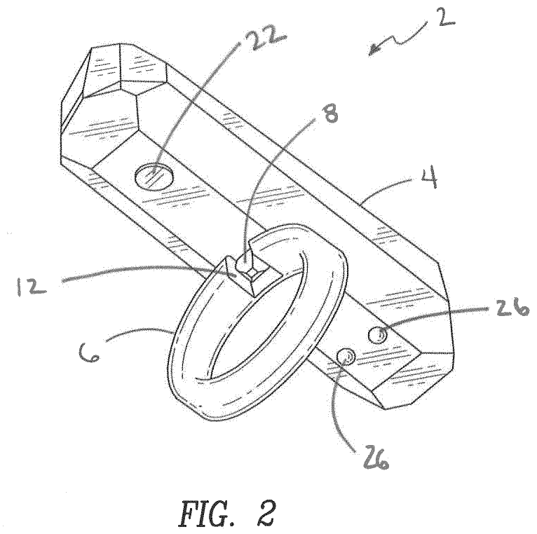

As shown in FIGS. 1-2, the present invention is directed to a vibration ring 2 comprising a housing 4 and a ring band 6. The housing 4 can be releasably mounted to the ring band 6 in a first orientation, such as with the ring band 6 oriented perpendicular to the length of the housing 4 as shown in FIG. 2, or in a second orientation, preferably with the ring band 6 oriented parallel to the length of the housing 4, not shown, as determined by the user.

Any suitable structure can be used to connect the housing 4 to the ring band 6, as long as it securely retains the housing 4 on the ring band 6 without rattling or slipping, and permits the user to orient the housing 4 on the ring band 6. In a preferred embodiment, the housing 4 and the ring band 6 have cooperating elements for attaching the housing 4 to the ring band 6, so that the ring band 6 can be removed from the housing 4 and reattached to the housing 4 in an alternative orientation. This embodiment permits the use of different sized ring bands 6 with a single housing 4, permitting the user to attach the housing 4 to a ring band sized 6 to fit the user's finger.

Alternatively, the housing 4 can be rotationally or slidably attached to the ring band 6, so that the orientation of the housing 4 on the ring band 6 can changed without removing the housing from the ring band. For example, a rotating disk can be fitted in the housing, the disk having notches that cooperate with a releasable catch. A button for releasing the catch can be incorporated on the exterior of the housing for the user to depress, allowing the disk to rotate to an alternative orientation, where the catch engages a different notch on the disk.

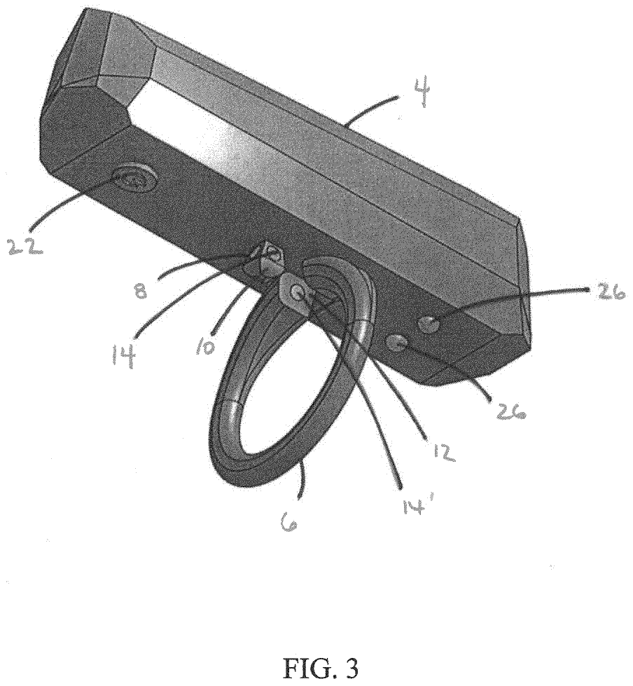

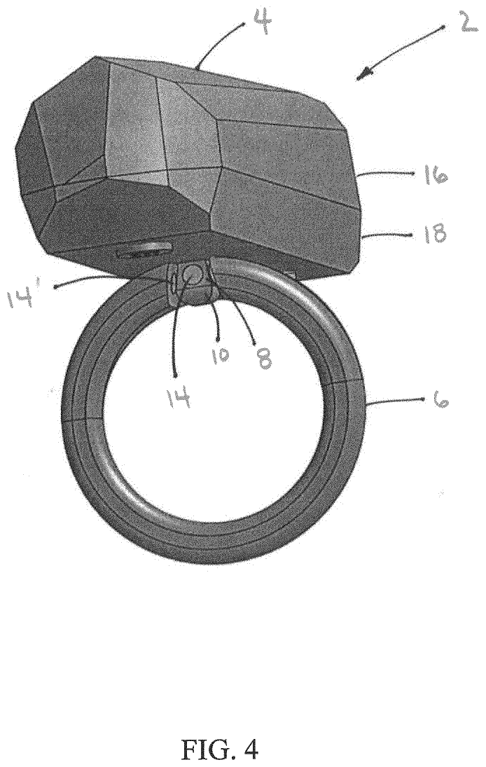

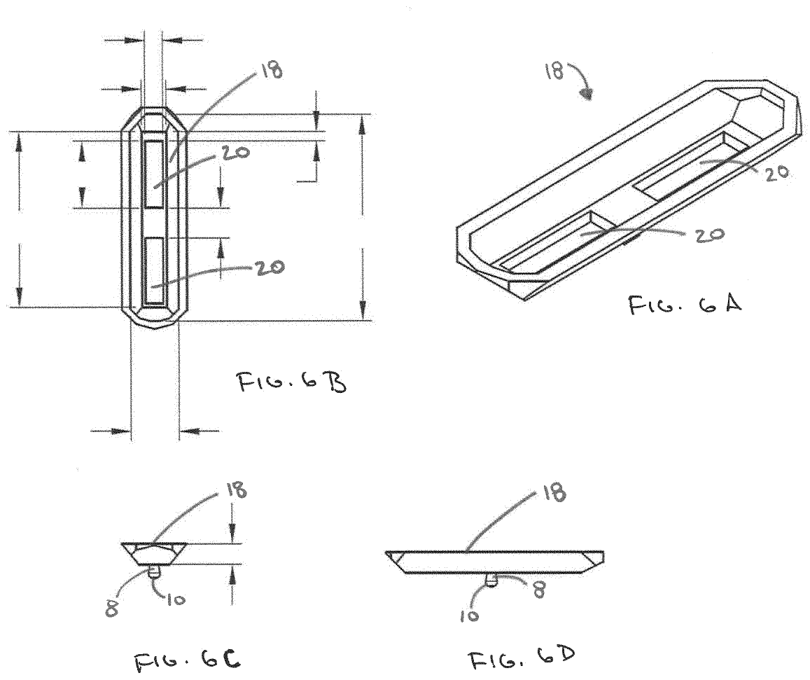

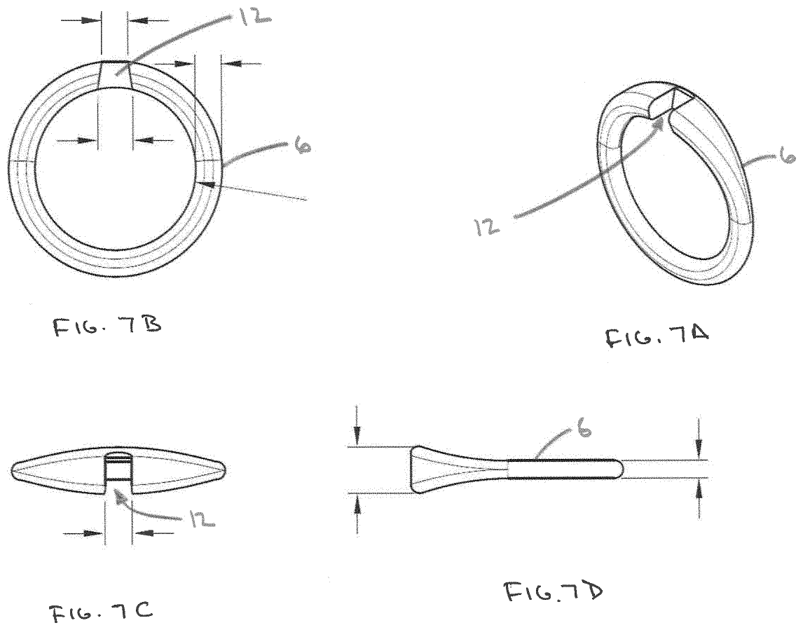

As shown in FIG. 3, a preferred embodiment for attaching the housing 4 to the ring band 6 includes a four-sided, symmetrical detent 8 extending from a portion of the housing 4 having an enlarged distal end 10, which is frictionally engaged by a receiver 12 on the ring band 6 having a cooperating shape. More particularly, as shown in FIGS. 3, 6C and 6D, the four sides of the detent 8 angle outwardly to the enlarged distal end 10, matching the outwardly angled side walls of the receiver 12, best shown in FIGS. 7A-7D and particularly FIG. 7B.

The corresponding shapes of the detent 8 and receiver 12 allow the ring band 6 to be slid off of the detent 8, rotated 90 degrees and slid back onto the detent 8. Thus, the housing 4 can be removably attached to the ring band 6 in either a first orientation or a second orientation.

In a most preferred embodiment, the mounting structure can further include a releasable securing member 14 to help maintain the housing in the user determined orientation on the ring band, the securing member being one or more of a magnet, clasp, pin, snap, clamp, spring ball or the like. In the preferred embodiment shown, the securing member comprises one or more cooperating magnets 14 and/or metallic elements on the detent 8 and the receiver 12. For example, the embodiment shown includes metallic elements 14 on two or more of the sides of the detent 8 and a cooperating magnet 14′ on at least one side of the receiver 12.

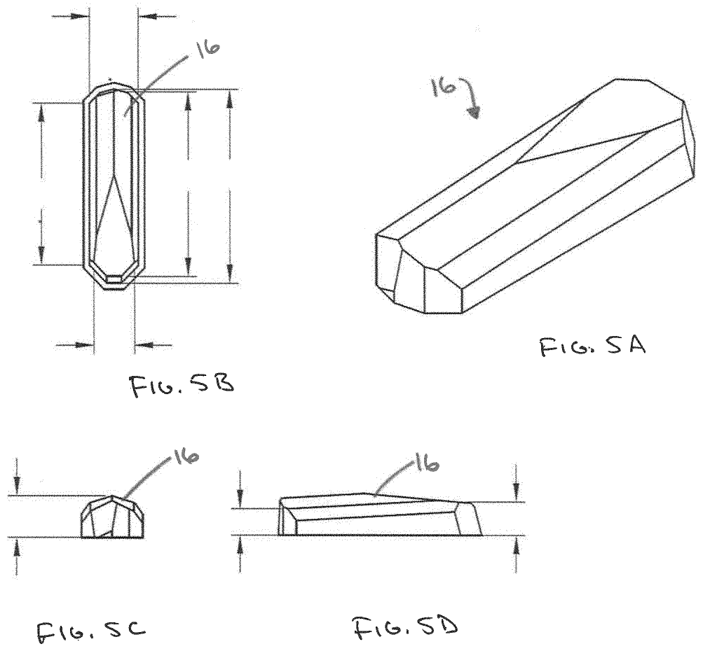

The housing 4 preferably comprises two or more housing sections that cooperate to house and protect the components contained within the housing 4. In the preferred embodiment shown, a top housing section 16 (shown in FIGS. 5A-5D) is attached to a bottom housing section 18 (shown in FIGS. 6A-6D). The top housing section 16 and bottom housing section 18 can be attached by any known method, including snap-fit tabs, ultrasonic welding, heat welding, adhesives or the like, and combinations thereof, such that when attached the housing sections 16, 18 provide a secure environment for the electronics components.

In a preferred embodiment, incorporating a rechargeable power source, the top housing section 16 and bottom housing section 18 are permanently attached by a combination of snap-fit tabs and an adhesive or welding. It is contemplated that assembly will be tested using a four foot drop test, such that if the housing opens, the vibration ring 2 does not turn on or the vibration ring 2 does not allow changes in programs in programming, the device will have failed.

Regardless of the method for attachment, it is preferred that when the top and bottom housing sections 16, 18 are attached, the housing 4 is water resistant, and most preferably waterproof, so that it can be cleaned or used underwater without damaging the electronic components contained therein. In the most preferred embodiment, waterproofing will be tested to an IPx7 standard.

As can be seen from FIGS. 6A-6D, the bottom housing section 18 preferably comprises one or more recesses 20 in which one or more of the electronic components can be seated during assembly. As shown in FIGS. 5A-5D, the top housing section 16 preferably includes sufficient interior headroom to snugly cover the electronic components, so that the components do not bounce around within the housing 4. When selecting the electrical components, consideration should be given to minimizing the size of the components, including the battery and circuit board.

Although any suitable control can be used to operate the vibration ring 2 and activate the user settings, including wireless controls using Bluetooth, Wi-Fi, or other wireless connections, the preferred embodiment uses a physical activator on the exterior of the housing 4 for user interface. As shown in FIG. 2, preferred physical activator comprises a multi-function button 22 for turning the vibration on and off and for selecting various mode and speed options.

The preferred vibration ring 2 provides mode and speed variations through a 2-axis and/or 3-axis gyroscope accelerometer, a motor, a computer chip/printed circuit board/processor including memory for storing various user selectable settings, a control to allow user determination of the vibration settings, and a power source.

In a preferred embodiment, the user preferred settings of the vibration ring 2 can be selected and saved by the user in the memory of the processor. This permits the user to select and store particular combinations of mode and speed that can be scrolled through or returned to for future use, as further described below.

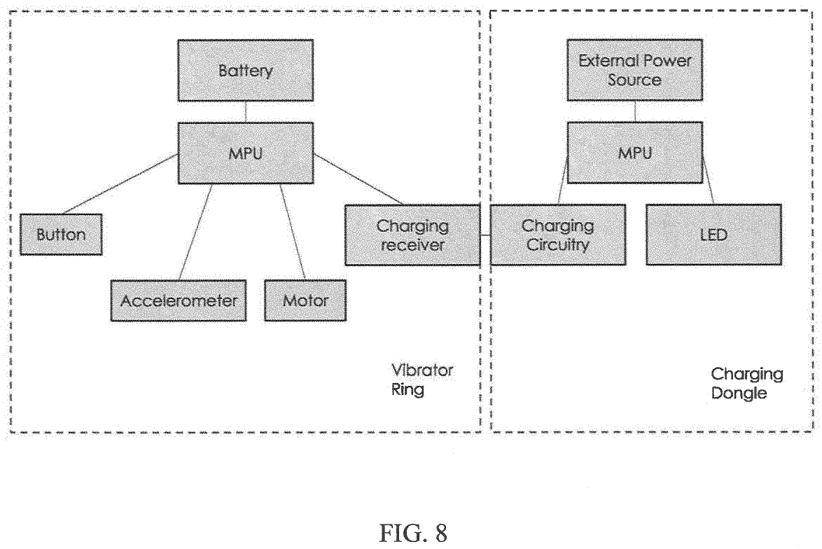

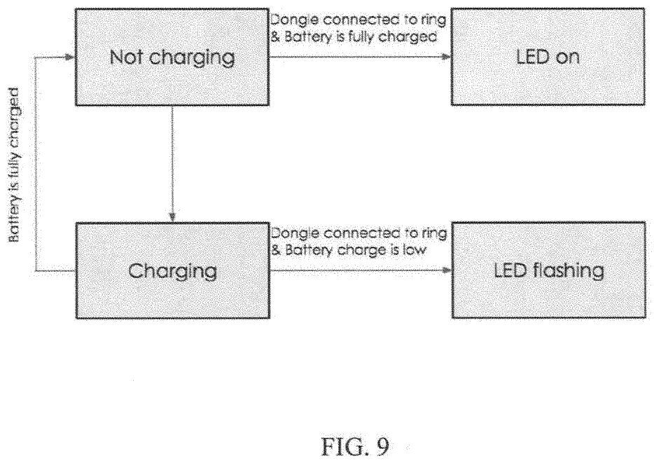

A suitable interface between the electronic components of the preferred vibration ring 2 is shown in FIG. 8. The diagram of FIG. 8 shows the interface between the contained electrical component parts and the parts of the contemplated charging dongle. A charging dongle may be preferred to wireless charging to reduce the size of the electronic components within the housing 4. The charging dongle will preferably include a flashing LED to indicate that the power source is charging, and the LED will remain on when the dongle is plugged into the power source that is fully charged, as shown in FIG. 9.

The power source is a preferably a rechargeable battery to eliminate the need to open the housing to change batteries. For example, a 10160 85 mAh lipo battery may be suitable for the invention. Although any charging method can be used to recharge the power source, including wireless charging, it is preferred that the power source be charged via charger contacts 26 accessible on the exterior of the housing 4.

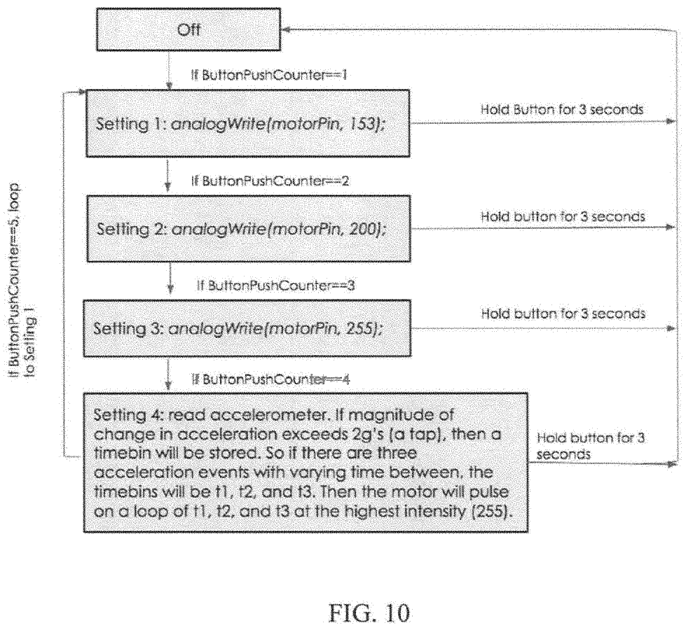

The accelerometer vibration patterns are programmed using the processor, preferably with combinations of depressions and tap-inputs by the user on the multi-function button 22 as shown in the flow diagram of FIG. 10. This permits the user to depress the multi-function button 22 to cycle through settings such as LOW, MEDIUM, HIGH, and CUSTOM, wherein when the user enters CUSTOM mode they will be able to tap-input the pattern via the accelerometer.

Notwithstanding, it is understood that any suitable control can be used in addition to or in place of the multi-function button 22, including wireless communications between the vibration ring 2 and smartphones, smart watches, dedicated remote controls, etc., generally maintaining the flow diagram for controlling the vibration ring 2 along the lines of that shown in FIG. 10 or with another programming pattern or user interface.

In the preferred embodiment, the top housing section 16, the bottom housing section 18, and ring band 6 are made of 316L stainless steel. The vibration ring 2 can either be finished by polishing, or plated with a suitable material such as 18 k gold or other precious metal. Ring bands 6 may be included in more than one size, with sizes 5, 6, 7, and 8 being most preferred. In a preferred embodiment, the runtime of the vibration ring 2 will be between about 45 minutes and 1 hour, depending on the settings selected.

Variations, modifications and alterations to the preferred embodiment of the present invention described above will make themselves apparent to those skilled in the art. All such changes are intended to fall within the spirit and scope of the present invention, limited solely by the appended claims.

Any and all patents and/or patent applications referred to herein are hereby incorporated by reference.

1. A vibration ring comprising a housing and a ring band, wherein the housing and the ring band comprise cooperating mounting members for mounting the housing on the ring band in a plurality of orientations.

2. The vibration ring of claim 1 wherein the ring band can be adaptable between a first orientation, with the ring band perpendicular to a length of the housing, and a second orientation, with the ring band parallel to the length of the housing, the orientation being configurable by the user.

3. The vibration ring of claim 1 wherein the housing further comprises one or more of a motor, an accelerometer, a computer chip/printed circuit board/processor, a user control activator and a power source.
